(19) United States
(12) Patent Application Publication
(10) Pub. No.: US 2007/0053089 A1
(43) Pub. Date: Mar. 8, 2007

(54) Color wheel

(75) Inventors: Ching-Hsiang Yu, Taoyuan Hsien (TW); Yen-Chen Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/504,644

(22) Filed: Aug. 16, 2006

(30) Foreign Application Priority Data
Sep. 2, 2005 (TW) 094130066

(51) Int. Cl. G02B 7/00

(52) U.S. Cl. 359/892

(57) ABSTRACT

A color wheel includes a color filter set, a carrier, and a cap. The color filter set has a through hole, a first side and a second side which is oppositely disposed. The carrier is disposed at the first side of the color filter set and has a first engaging portion. The cap is disposed at the second side of the color filter set and has a second engaging portion for coupling with the first engaging portion, wherein either the first engaging portion or the second engaging portion passes through the through hole.

### CROSS REFERENCE TO RELATED APPLICATIONS

This Non-provisional application claims priority under 35 U.S.C. §119(a) on Patent Application No(s). 094130066 filed in Taiwan, Republic of China on Sep. 2, 2005, the entire contents of which are hereby incorporated by reference.

### BACKGROUND OF THE INVENTION

1. Field of Invention

The invention relates to an optical element, and in particular to a color wheel.

2. Related Art

Digital Light Processing (DLP) projector has advantages such as large display area, and thin and light composition, so DLP projector becomes a widely used in projection market.

Conventionally, a digital control method and a reflection principle are adopted to a DLP projector. Light rays from the light source are collected and focused by the lens, and then pass through the color wheel for separating the light rays. The light rays are then projected onto a Digital Micro-mirror Device (DMD). In a DLP projector, DMD functions as the LCD panel in the traditional LCD projector. Since the DMD includes several movable micro mirrors, this drives electrodes to control the tilt angle and deflection time of the movable micro mirrors. Then, the light rays are projected to form an image by switching the direction of the light ray reflections. Herein, the quality of the color wheel may influence the quality of the color, so that the assembling stability of the color wheel is an important issue for the users and the manufacturers.

Please refer to FIG. 1, a conventional color wheel 1 is constituted by a fastener ring 11, a color filter set 12 and a carrier 13. During the assembling process of the color wheel 1, the surface of the carrier 13 is coated with an adhesive, and then a flange 131 of the carrier 13 is sleeved with the central hole 121 of the color filter set 12. Afterward, the flange 131 of the carrier 13 is further sleeved with the through hole 111 of the fastener ring 111, so that the color filter set 12 can be fixed on the surface of the carrier 13 with the adhesive and fastener ring 11 strengthen the fixing force.

For satisfying the high color requirement in the market and solving the problem of the image persistence, the rotation speed of the color wheel 1 is increased from 3600 rpm or 7200 rpm to 9000 rpm, even to 10800 rpm. Possibly, the rotation speed of the color wheel 1 will be increased to 14400 rpm or the higher in the future.

However, considering of the structure of the conventional color wheel 1, because the fastener ring 11, the color filter set 12 and the carrier 13 are adhered together only with the adhesive, the color filter set 12 may be shifted, separated from the carrier 13, cracked or even fallen if the adhesive can not bear the centrifugal force when the color wheel 1 rotates at high speed.

For the current trend towards the color wheel at the high speed, the longer lifetime and the lower-noise of the motor and the higher assembling stability between the carrier 13 and the color filter set 12 are needed.

In view of the above-mentioned problem, it is an important subject of the invention to provide a color wheel capable of increasing assembling stability.

### SUMMARY OF THE INVENTION

In view of the foregoing, the invention is to provide a color wheel to solve the above problems such as poor assembling stability of the carrier and the color filter set.

To achieve the above, a color wheel of the invention includes a color filter set, a carrier, and a cap. The color filter set has a through hole, a first side and a second side which is oppositely disposed. The carrier is disposed at the first side of the color filter set and has a first engaging portion corresponding to the through hole. The cap is disposed at the second side of the color filter set and has a second engaging portion for coupling with the first engaging portion, wherein either the first engaging portion or the second engaging portion passes through the through hole.

To achieve the above, a color wheel of the invention includes a color filter set, a carrier and a fastening element. The color filter set has a through hole and a first side, and the carrier is disposed at the first side of the color filter set and has a first indention corresponding to the through hole. The fastening element penetrates through the through hole for being connected with the first indentation of the carrier.

As the above-mentioned color wheel, the first indentation is disposed on the carrier and facing the color filter set, and the color wheel may further include a buffer element located between the fastening element and the color filter set.

In summary, the color wheel of the invention utilizes the connection relationship of the protrusion of the cap and the indentation of the carrier to increase the assembling stability of the color wheel, particularly to increase the connection forces between the cap and the carrier, and also protect the color filter set. Alternatively, a fastening element is applied in connecting the color filter set and the carrier so as to increase the assembling stability of the color filter set. In addition, there is an adhesive disposed at a connection between the color filter set and the carrier so as to increase the connecting strength against the centrifugal force when the color wheel rotates at high speed. Comparing with the prior art, the invention can increase the assembling stability and prevent the color filter set from being shifted, separated from the carrier, cracked or even fallen when the color wheel rotates at high speed. Further, the quality of the product can also be improved.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional color wheel;

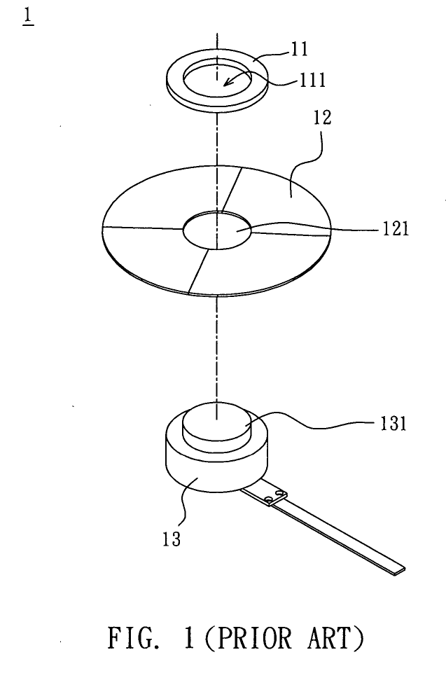

FIG. 2 is a schematic view of a color wheel according to a first embodiment of the invention;

FIG. 3 is another schematic view of the color wheel according to the first embodiment of the invention;

FIG. 4 is a schematic view of a color wheel according to a second embodiment of the invention;

FIG. 5 is a schematic view of a color wheel according to a third embodiment of the invention; and

FIG. 6 is a schematic view of a color wheel according to a fourth embodiment of the invention.

### DETAILED DESCRIPTION OF THE INVENTION

The present invention will be apparent from the following detailed description, which proceeds with reference to the accompanying drawings, wherein the same references relate to the same elements.

First Embodiment

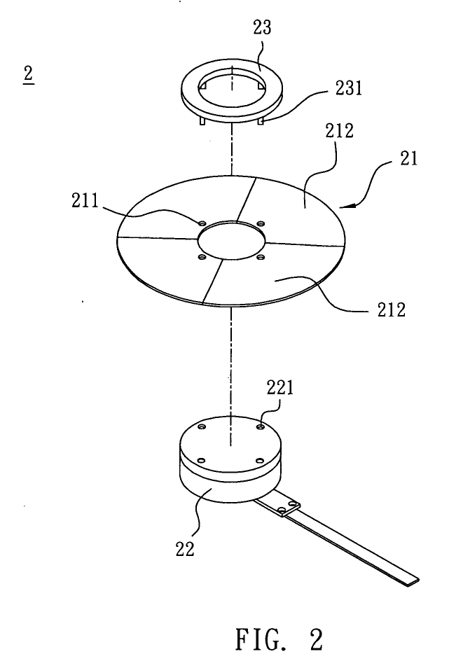

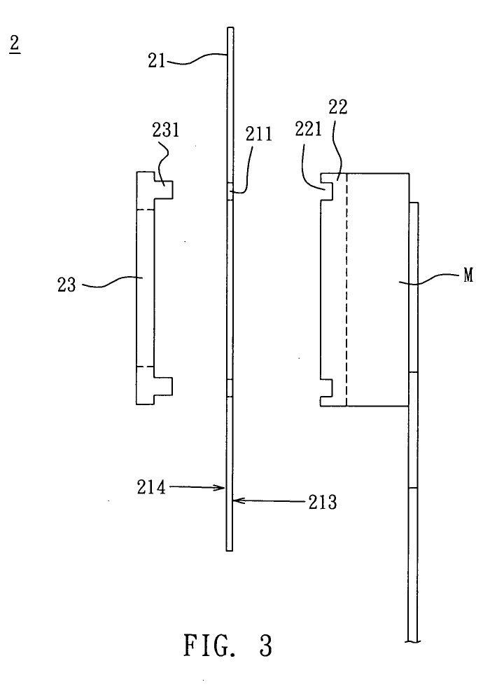

Referring to both FIGS. 2 and 3, a color wheel 2 according to a first embodiment of the invention includes a color filter set 21, a carrier 22 and a cap 23.

The color filter set 21 has at least one through hole 211, or preferably more than through hole 211, as long as these through hole are symmetrically arranged on the color filter set 21. In this embodiment, the color filter set 21 is a flat ring-shaped structure constituted by one or more color filter sheets 212. Preferably, each color filter sheets 212 has a through hole 211. The color filter set 21 has a first side 213 and a second side 214 which is oppositely disposed to the first side 213. Herein, the color filter set 21 is connected to the carrier 22.

The carrier 22 is disposed at the first side 213 of the color filter set 21 and has at lease one first engaging portion 221, such as an indention, corresponding to the through hole 211. Herein, there are four indentations 221 disposed on the carrier 22 and facing the color filter set 21. Alternatively, the first engaging portion 221 may pass through the carrier 22 to form a hole on the carrier 22. Moreover, the carrier 22 is attached to a motor M. When the motor M operates, the motor M drives the carrier 22 to rotate, and the color filter set 21 adhered to the carrier 22 is also driven to rotate.

The cap 23 is disposed at the second side 214 of the color filter set 21 and has at lease one second engaging portion 231, such as a protrusion, corresponding to the through hole 211 and the first engaging portion 221 for coupling with the first engaging portion 221. Herein, the cap 23 has four protrusions 231 for coupling with the first engaging portion 221. The protrusions 231 respectively pass through the through holes 211 and connect with the indentations 221 of the carrier 22 so that the color filter set 21, the carrier 22 and the cap 23 are assembled and combined together. In this embodiment, the size and the shape of the through holes 211 can be adjusted according to practical needs, and the indentation 221 can be hole-shaped, groove-shaped or has any other shape.

In addition, the color filter set 21 is adhered to the carrier 22 by an adhesive, and the adhesive is disposed at a connection between the first engaging portion 221 and the second engaging portion 231, so as to increase the connecting strength. Herein, the adhesive may be a light curing adhesive or a thermal curing adhesive. Additionally, the cap 23 is a ring-shaped structure or a block-shaped structure. The shape of the cap 23 is not limited as long as the cap 23 does not interrupt the light pathway to the color filter set 21.

During the assembling process of this embodiment, the connection relationship of the first engaging portion of the carrier and the second engaging portion of the cap can increase the assembling stability of the color wheel 2, and the adhesive also increase the connecting strength of the carrier 22 and the cap 23 against the centrifugal force when the color wheel 2 rotates at high speed. Also, the displacement or the fall of the color filter set 21 can be prevented.

Second Embodiment

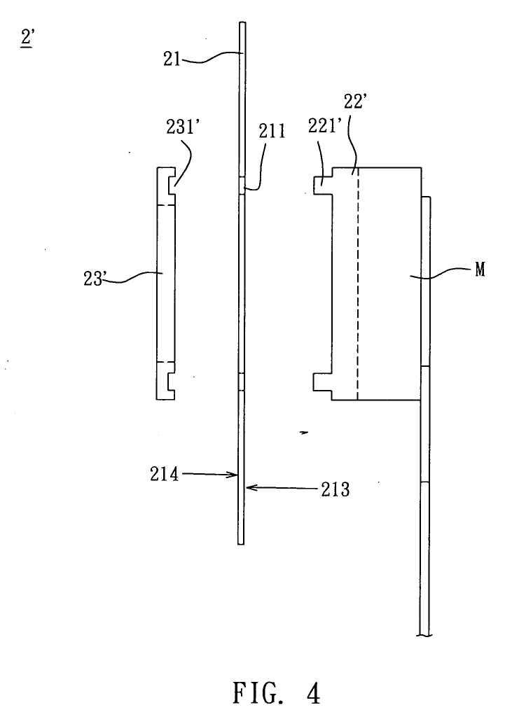

Referring to FIG. 4, a color wheel 2′ of a second embodiment of the invention includes a color filter set 21, a carrier 22′ and a cap 23′. In this embodiment, the functions and the features of the color filter set 21 are same as those of the color filter set 21 in the first embodiment, detailed description thereof will be omitted.

The carrier 22′ is disposed at the first side 213 of the color filter set 21 and has at lease one first engaging portion 221′, such as a protrusion, corresponding to the through hole 211. Herein, there are four protrusions 221′ disposed on the carrier 22′ and facing the color filter set 21.

The cap 23′ is disposed at the second side 214 of the color filter set 21 and has at lease one second engaging portion 231′, such as an indention, corresponding to the through hole 211 and the first engaging portion 221′. Herein, the cap 23′ has four indentions 231′ for being connected with the first engaging portion 221′.

The protrusion 221′ of the carrier 22′ respectively pass through the through holes 211 and connect with the indentations 231′ of the cap 23′ so that the color filter set 21, the carrier 22′ and the cap 23′ are assembled and combined together. Moreover, the carrier 22′ is attached to a motor M. When the motor M operates, the motor M drives the carrier 22′ to rotate, and the color filter set 21 adhered to the carrier 22′ is also driven to rotate.

Alternatively, the second engaging portion 231′ may pass through the cap 23′ to form a hole on the cap 23′.

Third Embodiment

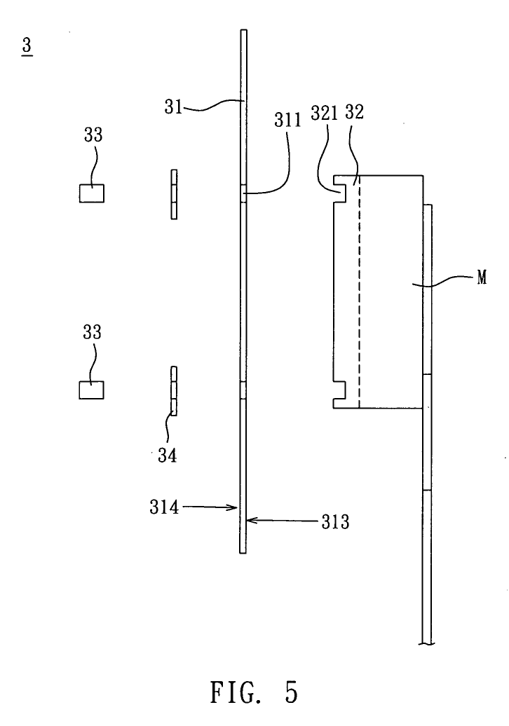

As shown in FIG. 5, a color wheel 3 of a third embodiment of the invention includes a color filter set 31, a carrier 32 and at least one fastening element 33. The color filter set 31 has at least one through hole 311, or preferably more than through hole 311, as long as these through hole are symmetrically arranged on the color filter set 31. In this embodiment, the color filter set 31 is a flat ring-shaped structure constituted by one or more color filter sheets. Preferably, each color filter sheets has a through hole 311. The color filter set 31 has a first side 313 and a second side 314 which is oppositely disposed to the first side 313. Herein, the color filter set 31 is connected to the carrier 22.

The carrier 32 is disposed at the first side 313 of the color filter set 31 and has a first indention 321 corresponding to the through hole 311 of the color filter set 31. Herein, there are at least two first indentations 321 disposed on the carrier 32 and facing the color filter set 31. Alternatively, each first indentation 321 may pass through the carrier 32 to form a hole on the carrier 32.

The fastening elements 33 respectively pass through the through holes 311 of the color filter set 31 for being connected with the first indentations 321 of the carrier 32, respectively. Herein, the fastening element 33 can be a pin, a spherical body, a rivet, and a pillar-shaped body, so as to fix the color filter set 31 to the carrier 32. In this embodiment, the color wheel 3 further includes at least one buffer element 34, such as a washer, located between the fastening elements 33 and the color filter set 31. The buffer elements 34 can increase the friction between the fastening element 33 and the color filter set 31, and prevent the fastening element 33 from falling. During the assembling process of the color wheel 3, the fastening elements 33 respectively penetrate through the buffer elements 34 and the through holes 311 in turn and connect with the first indentations 321 of the carrier 32, respectively.

Moreover, the color filter set 31 is adhered to the carrier 32 by an adhesive disposed at a connection between the fastening elements 33 and the first indentions 321 of the carrier 32, so as to increase the connecting strength. Herein, the adhesive is a light curing adhesive or a thermal curing adhesive. Additionally, the carrier 32 is attached to a motor M. When the motor M operates, the motor M drives the carrier 32 to rotate, and the color filter set 31 adhered to the carrier 32 is also driven to rotate.

In this embodiment, the size and the shape of the through holes 311 can be adjusted according to practical needs, and the first indentation 321 can be hole-shaped, groove-shaped or has any other shape.

Fourth Embodiment

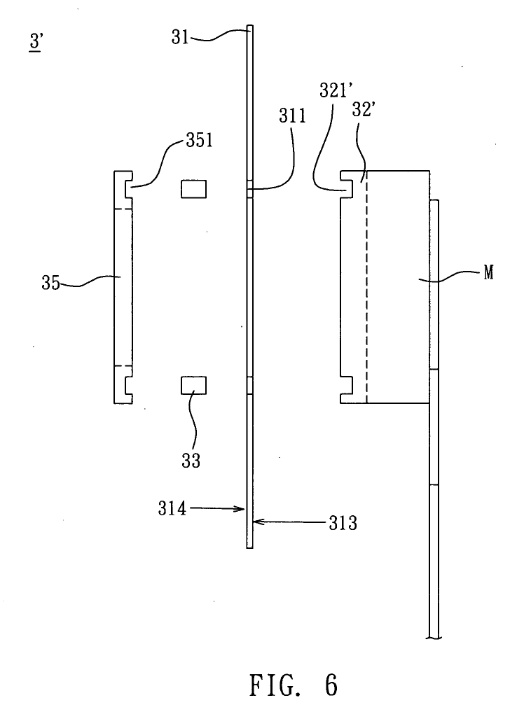

Referring to FIG. 6, a color wheel 3′ of a fourth embodiment of the invention includes a color filter set 31, a carrier 32′, at least one fastening element 33 and a cap 35. In this embodiment, the functions and the features of the color filter set 31 and the fastening elements 33 are same as those of the color filter set 31 and the fastening elements 33 in the third embodiment, so detailed description thereof will be omitted.

The carrier 32′ is disposed at the first side 313 of the color filter set 31 and has a first indention 321′ corresponding to the through hole 311 of the color filter set 31. Herein, there are at least two first indentations 321′ disposed on the carrier 32 and facing the color filter set 31. Alterntively, each first indentation 321′ may pass through the carrier 32′ to form a hole on the carrier 32′.

The fastening elements 33 respectively pass through the through holes 311 of the color filter set 31 for being connected with the first indentations 321 of the carrier 32, respectively. The cap 35 has at least one second indentation 351 facing the color filter set 31. Alterntively, each second indentation 351 may pass through the carrier 35 to form a hole. The cap 35 is disposed at the second side 314 of the color filter set 31.

During the assembling process of the color wheel 3′, the fastening elements 33 respectively penetrate through the through holes 311 and connect with the first indentations 321′ and the second indentations 351, respectively. As the result, the first indention 321′ of the carrier 32′ and the second indention 351 of the cap 35 are connected to two ends of the fastening element 33, respectively so that the carrier 32′, the color filter set 31, and the cap 35 are combined together. In this embodiment, the size and the shape of the through hole 311 can be adjusted according to practical needs, and the first indentation 321′ and the second indentation 351 can be hole-shaped, groove-shaped or have any other shapes.

One end of the fastening element 33 connects with the first indentation 321′ and the other end of the fastening element 33 connects with the second indentation 351. Of course, it is possible to apply an adhesive to be disposed at a connection between the fastening element 33 and the first indention 321′. Also, the adhesive can be disposed at a connection between the fastening element 33 and the second indention 351. Therefore, the adhesive can increase the connecting strength. Herein, the adhesive can a light curing adhesive or a thermal curing adhesive. Additionally, the carrier 32′ is attached to a motor M. When the motor M operates, the motor M drives the carrier 32′ to rotate, and the color filter set 31 adhered to the carrier 32′ is also driven to rotate.

In the above-mentioned embodiments, the color filter set with four through holes is for illustrating only, and thus is not limitative of the present invention. The number of the through hole can be adjusted according to practical needs, and is not limitative of the present invention.

In the first and second embodiments, either the first engaging portion or the second engaging portion passes through the through hole of the color filter set. In the third and fourth embodiments, a fastening element is used to penetrate through the through hole for being connected with the carrier and/or the cap. In summary, the color wheel of the invention utilizes the connection relationship of the protrusion of the cap and the indentation of the carrier to increase the assembling stability of the color wheel, particularly to increase the connection forces between the cap and the carrier, and also protect the color filter set. Alternatively, a fastening element is applied in connecting the color filter set and the carrier so as to increase the assembling stability of the color filter set. In addition, there is an adhesive disposed at a connection between the color filter set and the carrier so as to increase the connecting strength against the centrifugal force when the color wheel rotates at high speed. Comparing with the prior art, the invention can increase the assembling stability and prevent the color filter set from being shifted, separated from the carrier, cracked or even fallen when the color wheel rotates at high speed. Further, the quality of the product can also be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A color wheel, comprising:
a color filter set comprising a through hole, a first side and a second side which is oppositely disposed;
a carrier disposed at the first side of the color filter set and comprising a first engaging portion corresponding to the through hole; and
a cap disposed at the second side of the color filter set and comprising a second engaging portion for coupling with the first engaging portion.

2. The color wheel according to claim 1, wherein either the first engaging portion or the second engaging portion passes through the through hole.

3. The color wheel according to claim 1, wherein the first engaging portion is disposed on the carrier and facing the color filter set.

4. The color wheel according to claim 1, wherein the color filter set is adhered to the carrier.

5. The color wheel according to claim 1, wherein there is an adhesive disposed at a connection between the first engaging portion and the second engaging portion.

6. The color wheel according to claim 5, wherein the adhesive is a light curing adhesive or a thermal curing adhesive.

7. The color wheel according to claim 1, wherein the first engaging portion is an indention and the second engaging portion is a protrusion, and vice versa.

8. The color wheel according to claim 1, further comprising a fastening element penetrating the through hole to connect the first and second engaging portions.

9. The color wheel according to claim 1, wherein the color filter set has at least one color filter sheet.

10. A color wheel, comprising:
a color filter set comprising a through hole and a first side;
a carrier disposed at the first side of the color filter set and comprising a first indention corresponding to the through hole; and
a fastening element penetrating through the through hole for being connected with the first indentation of the carrier.

11. The color wheel according to claim 10, wherein the first indentation is disposed on the carrier and facing the color filter set.

12. The color wheel according to claim 10, further comprising a buffer element located between the fastening element and the color filter set.

13. The color wheel according to claim 10, wherein the color filter set is adhered to the carrier.

14. The color wheel according to claim 10, wherein there is an adhesive disposed at a connection between the fastening element and the first indention.

15. The color wheel according to claim 14, wherein the adhesive is a light curing adhesive or a thermal curing adhesive.

16. The color wheel according to claim 10, further comprising a cap which comprises a second indention for coupling with the fastening element, wherein the color filter set further comprises a second side oppositely disposed to the first side, and the cap is disposed at the second side of the color filter set.

17. The color wheel according to claim 10, wherein the first indention of the carrier and the second indention of the cap are connected to two ends of the fastening element, respectively.

18. The color wheel according to claim 10, wherein the fastening element is a pin, a spherical body, a rivet, and a pillar-shaped body.

19. The color wheel according to claim 10, wherein the color filter set has at least one color filter sheet.
